(19) United States
(12) Patent Application Publication
(10) Pub. No.: US 2006/0261680 A1
(43) Pub. Date: Nov. 23, 2006

(54) Vibration type tilting device and image projection device having the tilting device

(75) Inventors: Yang-Ho Moon, Ansan-si (KR); Chil-Sung Lee, Suwon-si (KR); Dong-Won Choi, Suwon-si (KR); Chang-Hwan Choi, Seongnam-si (KR); Jae-Kyung Kim, Ansan-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRO-MECHANICS CO., LTD., Suwon (KR)

(21) Appl. No.: 11/417,224

(22) Filed: May 4, 2006

(30) Foreign Application Priority Data
May 4, 2005 (KR) 10-2005-0037767

(51) Int. Cl. H02K 41/00; H02K 35/00

(52) U.S. Cl. 310/14; 310/15; 359/291; 359/225

(57) ABSTRACT

A tilting device for repeatedly tilting light reflected from a micro-mirror device, and a vibration type tilting device and an image projection device having the tilting device are disclosed, which uses viscous fluids to improve vibration performance. A vibration type tilting device, comprising a tilting part which vibrates periodically to tilt an incident light by a predetermined angle, and a driving part which provides driving power to the tilting part, may not only provide a smooth and natural display by periodically tilting light reflected from a digital micro-mirror device in constant time intervals but also may reduce overshooting and residual vibration of the tilting part.

### CROSS-REFERENCE TO RELATED APPLICATIONS

This application claims the benefit of Korean Patent Application No. 2005-37767 filed with the Korea Industrial Property Office on May 4, 2005, the disclosure of which is incorporated herein by reference.

### BACKGROUND

1. Technical Field

The present invention relates to a tilting device, and in particular, to a vibration type tilting device and an image projection device having the tilting device, which uses viscous fluids to improve vibration performance.

2. Description of the Related Art

An image projection device using digital light processing (DLP), in which the mosaic phenomenon in pixels, a problem in regular liquid crystal display (LCD) imaging devices, is eliminated to improve the ability to reproduce original colors, is used widely in theaters, conference rooms, and projection TV's, etc. The image projection device can be divided into a Front Projection device and a Rear Projection device according to the projection method.

The Front Projection device adopts the method of projecting image signals from the front, and is generally used in theaters, conference rooms, etc. On the other hand, the Rear Projection device adopts the method of projecting image signals from the rear of the screen. The Rear Projection device is commonly used in the form of projection TV's. In particular, Rear Projection devices are used more often than Front Projection devices, because of its ability to display a relatively bright image even in a bright environment.

FIG. 1 is a perspective view illustrating a conventional image projection device, and FIG. 2 is a schematic drawing illustrating the pixel structure shown on a screen by a conventional image projection device.

As shown in FIG. 1, a conventional image projection device comprises a lamp 11, a condenser lens 13 which collimates and irradiates light emitted from the lamp 11, a color wheel 15 which separates the collimated white light into red (R), green (G), and blue (B) colors and illuminates ⅓ for every frame, a collimation lens 17 which irradiates parallel the light emitted from the color wheel 15 for each color, a digital micro-mirror device 19 (hereafter referred to as “DMD”) which adjusts the reflection angle for each pixel of the light collimated from the collimation lens 97 for each color to form a picture, and a projection lens 21 which projects the light from the DMD to a large display of a screen S.

On the DMD 19 are formed numerous micro-mirrors (not shown), which are minute in size and are associated with a pixel structure on a silicon wafer, and these micro-mirrors convert the path of the incident light on/off by individually undergoing a highly rapid tilting motion according to the digital information provided to the DMD 19 by a controller. The pixels controlled individually by the DMD 19 are magnified through a projection lens 21 so that a large display picture is formed on the screen S.

As described above, since conventional image projection devices form a large display simply through the magnified projection of the small original picture, there is the problem that the picture quality is degraded due to the grid pattern formed between each pixel P, as seen in FIG. 2. Also, there is a problem in that when the picture moves rapidly or where the line of sight of the viewer moves rapidly, the picture is formed on the screen with rainbow colors showing where the contrast ratio is great, for example where there are black stripes on a white background, or with the grid pattern between each pixel notably significant.

### SUMMARY

One aspect of the present invention provides a vibration type tilting device and an image projection device having the tilting device which provide a smooth and natural display by periodically tilting light reflected from a digital micro-mirror device in constant intervals and reflecting it onto a screen.

Another aspect of the invention provides a vibration type tilting device and an image projection device having the tilting device which reduce overshooting and residual vibration of the tilting part.

Additional aspects and advantages of the present invention will be set forth in part in the description which follows and, in part, will be obvious from the description, or may be learned by practice of the invention.

A vibration type tilting device according to an embodiment of the invention may comprise a tilting part which vibrates periodically to tilt an incident light by a predetermined angle, and a driving part which provides driving power to the tilting part, where the tilting part is damped by a viscous fluid during vibration. The tilting part may vibrate due to electromagnetic force generated by the driving part.

The tilting part may comprise a mirror reflecting light, a mirror holder having the mirror joined to a side thereof, and a coil joined to the reverse side of the mirror holder, and the driving part may comprise a magnet positioned inside the coil and generating a magnetic field passing through the coil. The driving part may further comprise a yoke to increase the strength of the magnetic field passing through the coil. Also, the driving part may be positioned with a particular amount of displacement from the tilting part and may be formed by a magnet generating a magnetic field passing through the coil, and a core in contact with the magnet. The viscous fluid may be positioned inside the coil or around the perimeter of the coil to transfer damping force.

Also, the driving part may comprise a core positioned with a particular amount of displacement from the mirror holder and having a portion thereof positioned inside the coil, a yoke positioned with a particular amount of displacement from the mirror holder and facing the perimeter of the coil, and a magnet positioned between the core and the yoke and magnetizing the core and the yoke, where the coil may be damped by a viscous fluid during vibration.

A vibration type tilting device based on the present invention may provide a clearer and smoother display by periodically reflecting with a mirror the light reflected from a digital micro-mirror device in constant time intervals. Also, a vibration type tilting device based on the present invention may reduce overshooting and residual vibration of the tilting part, as during the vibration of the tilting part, which comprises a mirror, mirror holder, and coil, the coil is damped by a viscous fluid. For viscous fluids, the increase rate of the rising time is not high, compared to those of other damping materials, such as rubber.

Preferably, the coil may be formed on the reverse side of the mirror holder in bilateral symmetry, so that the same amount of force is transferred to both sides of the vibration axis on the mirror holder. The core may comprise an insertion part positioned inside the coil, and a fixation part having a diameter greater than that of the insertion part and formed on one end of the insertion part. The magnet may be inserted onto the insertion part and mounted on the fixation part

The viscous fluid may be inserted into a space formed between the coil and the core or into a space formed between the coil and the yoke. The viscous fluid may also be inserted in both the space formed between the core and the coil and the space formed between the coil and the yoke. It may be preferable to insert a magnetic fluid between the core and the magnet, to prevent leakage and evaporation of the viscous fluid. A viscous fluid may be inserted into the portion where the magnetic fluid is inserted.

It may be preferable for the viscous fluid to have a viscosity of 5,000-20,000 mPa·s, to obtain appropriate levels for the rising time and overshooting. Grease, glycerin, UV-setting silicone, castor oil, SAE 30 oil, SAE 10W-30 oil, or SAE 10W oil, etc., may be used for the viscous fluid.

A consistency of 200-500 may be preferable for grease, using silicone oil, etc. as the base oil, and lithium, PTFE, or PAO, etc. as the thickener, so that the consistency is not varied greatly at high temperatures.

An image projection device based on an embodiment of the invention includes a vibration type tilting device based on an embodiment described above, and may comprise a light source, a color separation means which separates light emitted from the light source, and an image forming means which uses light transmitted from the color separation means to form an image, where the vibration type tilting device periodically may tilt in a particular angle the light transmitted from the image forming means.

A color wheel comprising red, green, and blue filters may be used as the color separation means. Also, a digital micro-mirror device may be used as the image forming means.

### BRIEF DESCRIPTION OF THE DRAWINGS

FIG. 1 is a schematic diagram of a conventional image projection device.

FIG. 2 is a schematic diagram illustrating the pixel structure shown on a screen by a conventional image projection device.

FIG. 3 is a perspective view illustrating the interior composition of a vibration type tilting device according to an embodiment of the invention.

FIG. 4 is a cross-sectional view illustrating a vibration type tilting device according to an embodiment of the invention, after a viscous fluid has been inserted between the coil and the core and between the coil and the yoke, and a magnetic fluid has been inserted between the core and the magnet.

FIG. 5 is a cross-sectional view illustrating the operation of a vibration type tilting device according to an embodiment of the invention.

FIG. 6 is a schematic diagram illustrating the tilting action of a vibration type tilting device according to an embodiment of the invention.

FIG. 7 is a schematic diagram illustrating the pixel structure shown on a screen by a vibration type tilting device according to an embodiment of the invention.

FIG. 8 is a schematic diagram illustrating a tilting part composed of a mirror, mirror holder, and coil, for testing the vibration properties of a tilting device with respect to changes in the damping properties of the tilting part.

FIG. 9 is a graph illustrating the displacement of the tilting part with respect to time, when the damping coefficient is 0.0005.

FIG. 10 is a graph illustrating the displacement of the tilting part with respect to time, when the damping coefficient is 0.0116.

FIG. 11 is a graph illustrating the displacement of the tilting part with respect to time, when the damping coefficient is 0.0068.

FIG. 12 is a graph illustrating changes in the rising time and overshooting of the tilting part with respect to changes in viscosity of the viscous fluid.

FIG. 13 is a schematic diagram of an image projection device according to an embodiment of the invention.

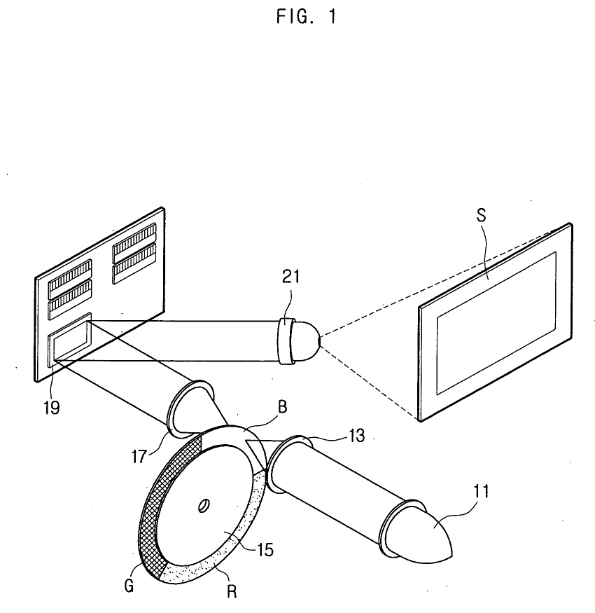

### DETAILED DESCRIPTION

Hereinafter, embodiments of the invention will be described in more detail with reference to the accompanying drawings. In the description with reference to the accompanying drawings, those components are rendered the same reference number that are the same or are in correspondence regardless of the figure number, and redundant explanations are omitted.

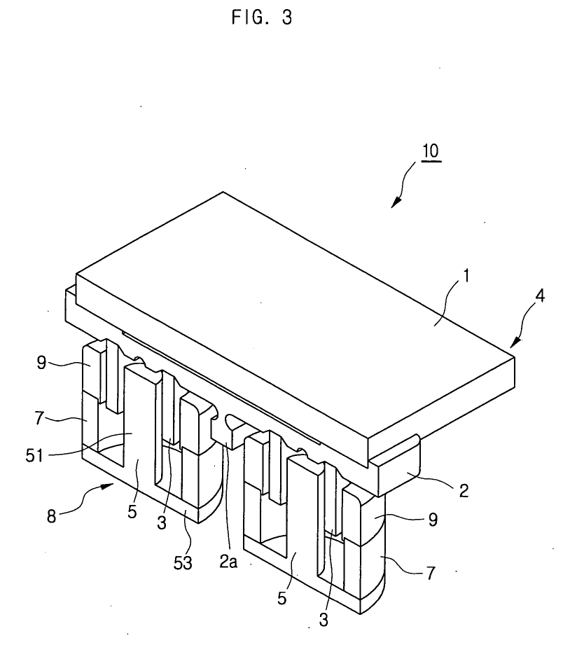

FIG. 3 is a perspective view illustrating a vibration type tilting device according to an embodiment of the invention. Referring to FIG. 3, a vibration type tilting device based on an embodiment of the invention includes a tilting part 4 comprising a mirror 1, a mirror holder 2 and a coil 3, and a driving part 8 comprising a core 5, a magnet 7, and a yoke 9.

The tilting part 4 vibrates, by means of the driving part 8, in constant periods and tilts light in a predetermined angle for projection onto a screen (not shown). Since the tilting part 4 is damped by a viscous fluid during vibration, the tilting device of the present invention may reduce overshooting and residual vibration of the tilting part 4. The driving part 8 supplies an electromagnetic force to the tilting part 4 and causes the tilting part 4 to vibrate.

The tilting part 4 comprises a mirror 1 which reflects light, a mirror holder 2 which supports the mirror 1, and a coil 3 which is attached to the reverse side of the mirror holder 2 to vibrate together with the mirror holder 2 due to the electromagnetic force generated by the driving part 8.

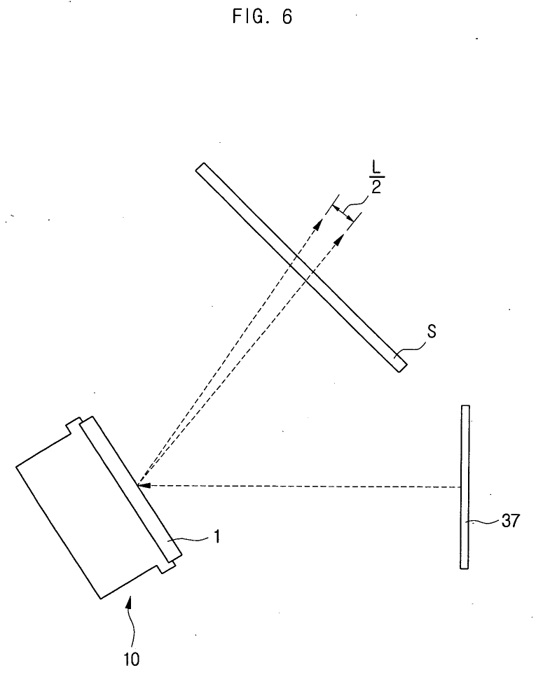

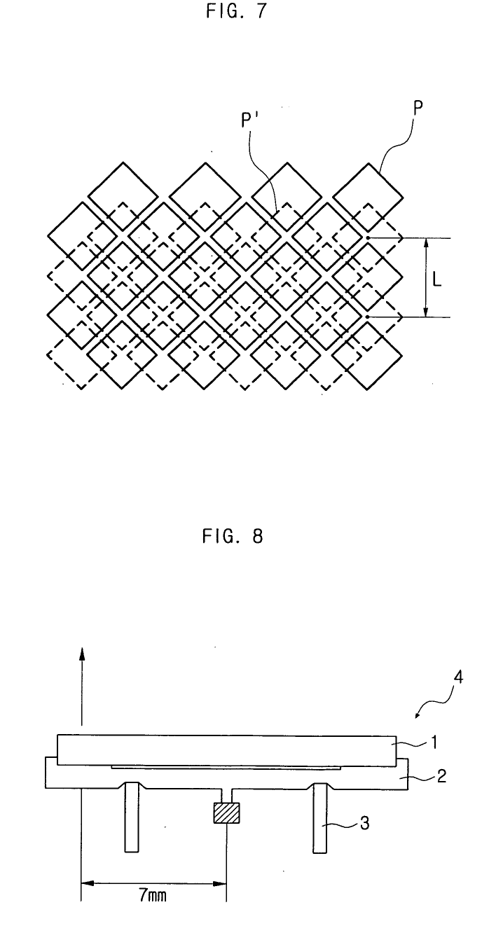

The mirror 1 is attached to the upper surface of the mirror holder 2, and periodically reflects the light reflected from a DMD 37 in a particular angle, as illustrated in FIG. 6. The mirror 1 raises the pixels, formed on the screen due to the tilting of light emitted from the DMD, by one half of the vertical distance L between pixels, i.e. L/2. This will be described in more detail below. Typical glass is used for the mirror 1. The mirror 1 may be of any shape, as long as it can reflect the light reflected from the DMD 19 onto the screen S.

The mirror holder 2 joins with the mirror 1 and supports the mirror 1. The coil 3 is joined to the reverse side of the mirror holder 2, and the mirror holder 2 vibrates about the vibration axis 2a by means of the forces applied on the coil 3. The angle by which the mirror holder 2 vibrates depends on the size of the screen, etc., but is generally about 0.015°. The mirror holder 2 vibrates together with the mirror 1 and the coil 3.

The coil 3 is attached to the reverse side of the mirror holder 2 in bilateral symmetry. A portion of the insertion part 51 of the core 5 is inserted through the inside of the coil 3. Also, the coil 3 is surrounded by the yoke 9. The magnetic field, generated by the magnetized core 5 and yoke 9, passes through the coil 3. Therefore, when an electric current is supplied to the coil 3, a force is applied on the coil 3 according to Fleming's Left Hand Rule. This force allows the tilting part 4, composed of the coil 3, the mirror 1, and the mirror holder 2, to vibrate. Preferably, the coil 3 is formed in bilateral symmetry about the vibration axis 2a of the mirror holder 2, so that the same amount of force is applied to both the left and right sides of the mirror holder 2. The mirror 1, mirror holder 2, and coil 3 consist the tilting part 4. As described below, the coil 3 is damped by the viscous fluid v, so that the overshooting and residual vibration of the tilting part 4 may be reduced.

The driving part 8 is formed with a particular amount of displacement from the tilting part and supplies electromagnetic force to the tilting part 4. The driving part 8 comprises a core 5, a magnet, and a yoke 9.

Although in this embodiment the driving part 8 comprises a core 5, a magnet 7, and a yoke 9, the invention is not thus limited, and any composition is sufficient which forms a magnetic field which supplies electromagnetic force to the tilting part 4. For example, the magnet 7 may be placed inside the coil 3, so that the magnetic field formed by the magnet 7 passes through the coil 3. Here, an additional yoke may be formed surrounding the coil 3 to concentrate the magnetic field on the coil 3. The viscous fluid may be inserted inside the coil or into a container surrounding the coil to transfer the damping force to the coil 3.

As illustrated in FIG. 3, the core 5 comprises an insertion part 51, a portion of which is positioned inside the coil 3, and a fixation part 53 on one end of the insertion part 51, having a diameter greater than that of the insertion part 51. The core 5 is displaced from the mirror holder 2 by a particular amount and secured to the bottom of the tilting device. The fixation part 53 touches the magnet 7 to be magnetized into an N-pole or an S-pole. Since the core 5 is secured to the bottom of the tilting device without joining with the mirror holder 2, the mass moment of inertia of the tilting part 4 may be reduced.

The magnet 7 is inserted onto the insertion part 51 of the core 5 and mounted on the fixation part 53. The magnet 7 may have a cylindrical or a quadrilateral shape. The magnet 7 magnetizes the core 5 and yoke 9 into N-/S-poles. Thus, the magnetized core 5 and yoke 9 create an effect similar to extending the magnet 7, by which a magnetic field is generated that passes through the coil 5. The magnet 7 is formed from a permanent magnet. Since the magnet 7 is joined to the core 5, and not joined to the mirror holder 2, it does not vibrate with the mirror 1 and mirror holder 2.

The yoke 9 is positioned at the upper portion of the magnet 7 and surrounds the coil 3. Thus, the yoke 9 is magnetized by the magnet 7, and together with the core 5 forms a magnetic field passing through the coil 3. The shape of the yoke 9 is not limited to a cylinder, and may be of any form, such as a quadrilateral, etc., which forms a magnetic field passing through the coil 3. Since the yoke 9 is joined to the magnet 7, and not joined to the mirror holder 2, it does not vibrate with the mirror 1 and mirror holder 2.

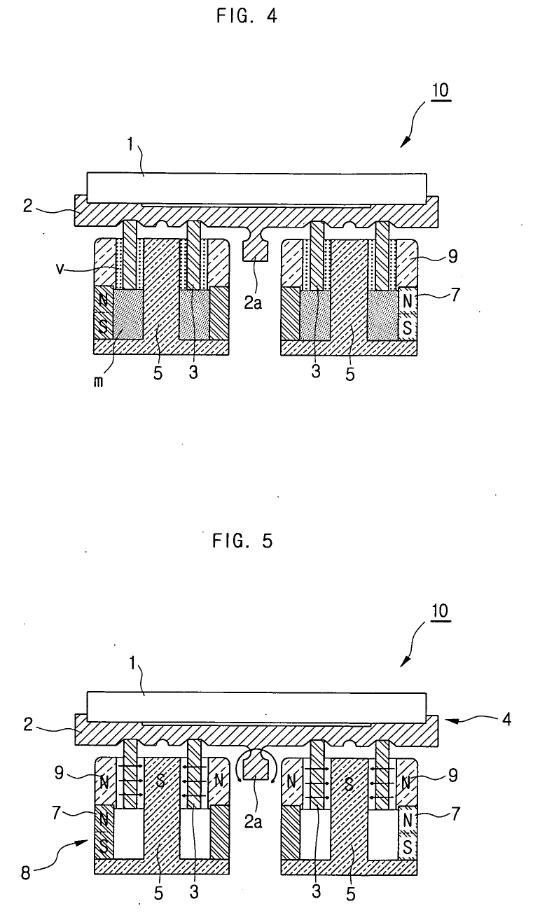

FIG. 4 is a cross-sectional view illustrating a vibration type tilting device according to an embodiment of the invention, after a viscous fluid v has been inserted between the coil 3 and the core 5 and between the coil 3 and the yoke 9, and a magnetic fluid m has been inserted between the core 3 and the magnet 7. The viscous fluid may also be inserted in the portion where the magnetic fluid m is inserted. That is, since there is no risk of leakage in the case of a highly viscous fluid, such as grease, it may not be necessary to insert a magnetic fluid.

As shown in FIG. 4, the viscous fluid v is inserted into the space formed between the coil 3 and the core 5 and/or the space formed between the coil 3 and the yoke 5. Thus, when the coil 3 undergoes vibration, a force is applied on the coil 3 by the viscous fluid v, where the force (τ) applied on the coil 3 is determined by the speed

$$\frac{ⅆ u}{( ⅆ y )}$$

and the coefficient of viscosity (μ) of the viscous fluid v, as in Equation 1 below.

$$τ = μ \frac{ⅆ u}{ⅆ y} \qquad Equation 1$$

Therefore, by controlling the damping coefficient of the tilting part 4 using a viscous fluid v having a constant coefficient of viscosity, the rising time, overshooting, and residual vibration of the tilting part 4 may be reduced. However, as using an excessive amount of viscous fluid or using a fluid with excessively high coefficient of viscosity may create an excessive damping action to increase the rising time, the fluid should be used of a moderate amount and moderate viscosity.

The damping coefficient of the tilting part 4 may vary according to the amount, viscosity, and position of the viscous fluid v, as well as the gap(s) between the coil 3 and the core 5 and/or the yoke 9 into which the viscous fluid v is inserted.

For the viscous fluid v, any fluid may be used which can provide a damping force to the coil 3. Also, it may be preferable to use a fluid that does not easily evaporate or leak while being inserted. Fluids such as grease, glycerin, UV-setting silicone, castor oil, SAE 30 oil, SAE 10W-30 oil, or SAE 10W oil, etc. may be used as the viscous fluid v.

For grease, a consistency of about 265-475 (National Lubricating Grease Institute standard) is desirable, using silicone oil, etc. as the base oil, and lithium, PTFE, or PAO, etc. as the thickener, so that the consistency is not varied greatly at high temperatures.

UV-setting silicone has a very high viscosity of 87,000 mPa·s (error range ±10,000), and is very stable, with almost no changes in viscosity within the temperature range of −40-80° C. Moreover, superior damping may be effected with only a small amount.

As glycerin has a coefficient of viscosity (μ) of 1.494 (kg/ms) at 20° C., and castor oil has a coefficient of μ≈1, a sufficient damping force may be transferred to the coil 3.

Also, μ=0.43 for SAE 30 oil, μ=0.17 for SAE 10W-30 oil, and μ=0.1 for SAE 10W oil, which are coefficients of viscosity much greater than that of water (μ=0.001), so that a damping force may be transferred efficiently to the coil 3.

The viscous fluid v is prevented from evaporating and leaking by the magnetic fluid m inserted in the space between the magnet 7 and the core 5. A magnetic fluid is a fluid in which magnetic powder is stabilized and dispersed in a liquid in the form of a colloid, after which a surfactant is added to prevent sedimentation or precipitation or condensation. Thus, due to the magnetic force of the magnet 7, the magnetic fluid m remains between the magnet 7 and the core 5. Therefore, the magnetic fluid m plays the role of preventing the evaporation and leakage of the viscous fluid v.

FIG. 5 is a cross-sectional view illustrating the operation of a vibration type tilting device according to an embodiment of the invention.

The N-pole of the magnet 7 is in contact with the yoke 9, and the S-pole is in contact with the core 5. Therefore, as the yoke 9 is magnetized into an N-pole and the core 5 is magnetized into an S-pole by the magnet 7, a magnetic field is generated in directions from the yoke 9 towards the core (as denoted by arrows). As the coil 3 is positioned between the core 5 and the yoke 9, the magnetic field passes through the coil 3. Therefore, when an electric current is supplied to the coil 3, a force is applied on the coil 3, according to Fleming's Left Hand Rule. Changing the intensity and direction of the electric current supplied to the coil 3 changes the force applied on the coil 3 and causes the coil 3 to vibrate. Also, the mirror holder 2 and mirror 1 connected to the coil 3 vibrate in constant intervals to tilt the light reflected from the DMD. During the vibration of the coil 3, the viscous fluid v transfers a damping force to the coil 3 to improve vibration performance, such as by reducing overshooting and residual vibration of the tilting part 4.

FIG. 6 is a schematic diagram illustrating the tilting action of a vibration type tilting device according to an embodiment of the invention, and FIG. 7 is a schematic diagram illustrating the pixel structure shown on a screen by a vibration type tilting device according to an embodiment of the invention.

The light reflected from a DMD 37 is transmitted to the mirror 1 of a vibration type tilting device based on the present invention. Here, the mirror 1 vibrates together with the mirror holder 2 and tilts the incident light in constant time intervals, as shown in FIG. 6. The speed of the tilting is generally 60 Hz, and may be varied as needed.

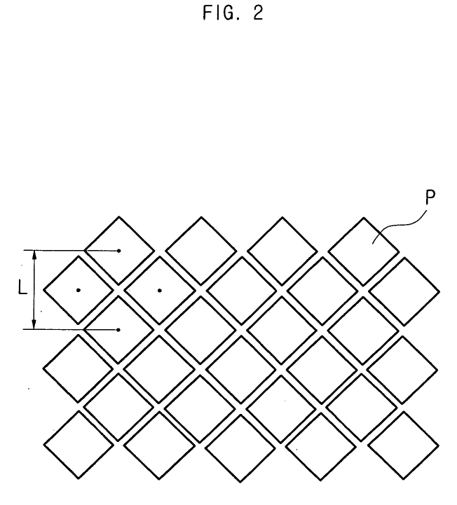

When the light transmitted from the DMD 37 is reflected by the mirror 1, an array of pixels P such as shown in FIG. 2 is formed on the screen S. In FIG. 2, the vertical distance between each pixel is L. When the mirror 1 rotates by about 0.015° due to the vibration of the tilting device 10, the light is tilted by 0.015° to form an array of pixels P′ raised on the screen S by L/2, as illustrated in FIG. 7. As described above, the vibration speed of the tilting device 10 is very fast, such as 60 Hz, so that the tilted pixels P′ are perceived as being continuously displayed on the screen due to a visual afterimage effect. Therefore, by removing the gap between pixels P using the tilted pixels P′, a natural and smooth image may be generated. Also, as the display is clearer, a viewer would not easily have tired eyes even with long hours of viewing. Further, by improving the damping property of the tilting device 10, the rising time and overshooting of the tilting part 4 may be reduced to provide a clearer picture quality.

FIG. 8 is a schematic diagram illustrating a tilting part composed of a mirror 1, mirror holder 2, and coil 3, for testing the damping properties of the tilting part 4. In the experiment, the vibration distance was measured of a point 7 mm away from the center of the mirror 1 using a vibrometer, as illustrated in FIG. 8.

### EXPERIMENT EXAMPLE

The displacement, rising time, and overshooting of the tilting part 4 were measured, while an electric current was supplied to the coil 3 to operate the tilting part 4, after grease containing a silicone-based base oil having a consistency of 282 (National Lubricating Grease Institute standard) and containing lithium as a thickener was inserted between the coil 3 and the core 5. Here, the mass moment of inertia of the tilting part 4 was I=8.84799E-07 (kg·mm²), the coefficient of elasticity was k=38.248 (N/m), and the damping coefficient was c=0.0068 (kg/ms).

### Comparison Example 1

No viscous fluid was used, while the damping coefficient of the tilting part 4 was set to 0.0005. Here, the mass moment of inertia and the coefficient of elasticity of the tilting part 4 were the same as in the Experiment Example.

### Comparison Example 2

Using a viscous fluid, the damping coefficient of the tilting part was set to 0.0116. Here, the mass moment of inertia and the coefficient of elasticity of the tilting part 4 were the same as in the Experiment Example.

Experiment Results

The rising time and overshooting of the tilting part 4 in the Experiment Example and Comparison Examples 1 and 2 are listed below in Table 1.

TABLE 1

| | Damping | | |
|---|---|---|---|
| | Coefficient | Rising Time | Overshooting |
| Comparison Example 1 | 0.0005 | 0.23 ms | 86.50% |
| Comparison Example 2 | 0.0116 | 1.35 ms | 0.0% |
| Experiment Example | 0.0068 | 0.42 ms | 9.40% |

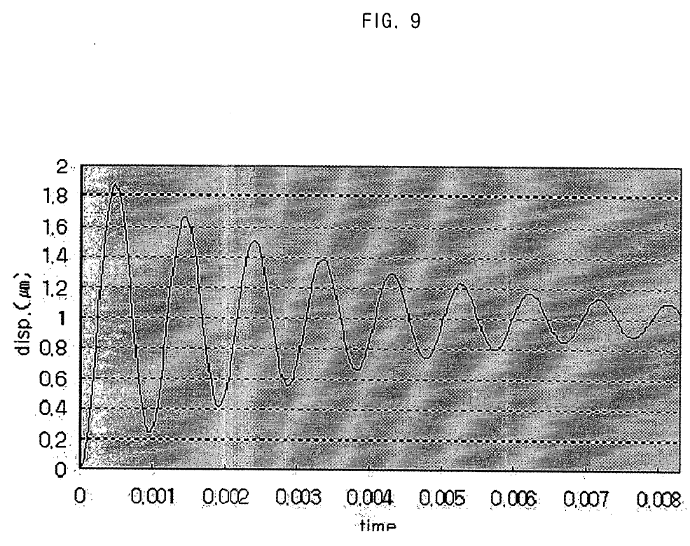

FIG. 9 is a graph illustrating the displacement of the tilting part 4 with respect to time, for Comparison Example 1. As seen in Table 1, the case with a damping coefficient lower, i.e. μ=0.0005, than that of the Experiment Example (μ=0.0068) had the shortest rising time of 0.23 ms, but also had the greatest overshooting, of 86.50%. In addition, as illustrated in FIG. 9, since there was inadequate damping, the tilting part 4 did not reach a steady state, even with the passage of time. Thus, although Comparison Example 1 might be superior in terms of tracking ability of the tilting part 4, the tilting part was not stable, so that there was a lot of residual vibration.

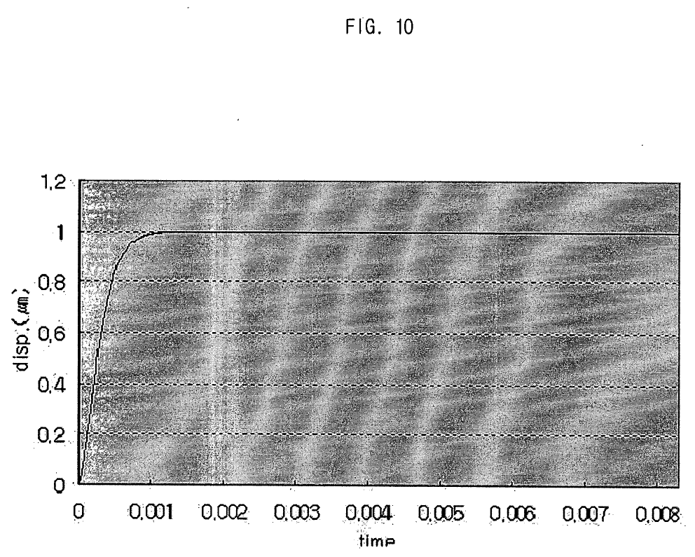

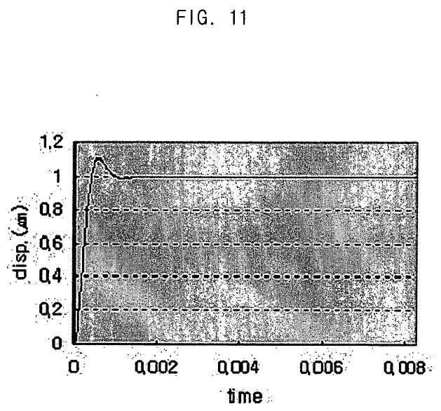

FIG. 10 is a graph illustrating the displacement of the tilting part 4 with respect to time, for Comparison Example 2. As seen in Table 1, the case with a damping coefficient higher, i.e. μ=0.0116, than that of the Experiment Example (μ=0.0068) had the longest rising time of 1.35 ms, but there was no overshooting. Thus, although there was no overshooting because of the great damping of the tilting part 4, the rising time was long, so that the tracking ability is significantly low.

FIG. 11 is a graph illustrating the displacement of the tilting part 4 with respect to time, for the Experiment Example. With the Experiment Example having a damping coefficient of μ=0.0068, the rising time was fast, to be 0.42 ms, and the possibility of overshooting was very low, to be 9.4%, whereby it was found that the tilting part 4 was very stable. Thus, not only was the tilting part of the Experiment Example superior in terms of tracking ability, but also there was barely any overshooting, so that the residual vibration of the mirror 1 was reduced to allow highly stable tilting.

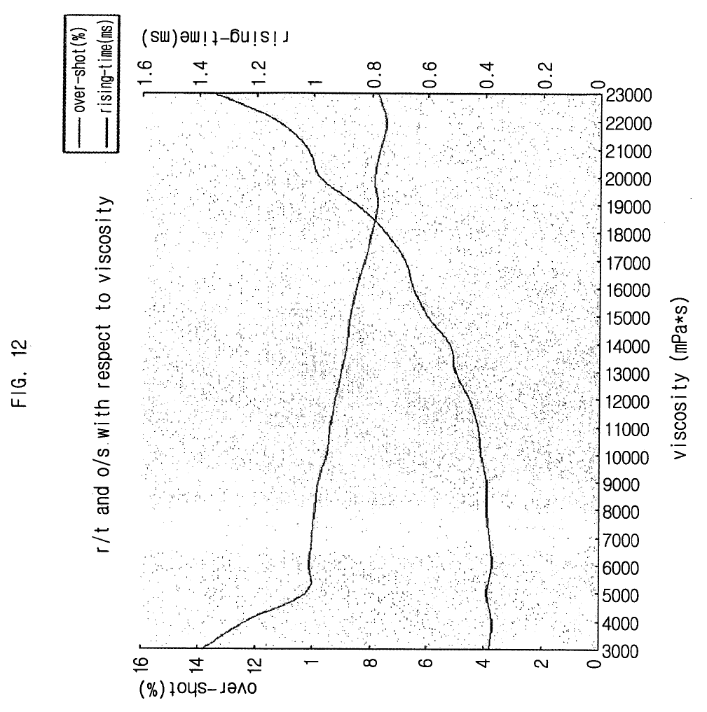

FIG. 12 is a graph illustrating the rising time and overshooting of the tilting part with respect to the viscosity of the viscous fluid.

Referring to FIG. 12, as the viscosity of the viscous fluid is increased, so is the damping effect increased on the tilting part 4, and so is the rising time increased. It is seen that in order for the rising time of the tilting part 4 not to exceed 1 ms, the viscosity of the viscous fluid must be maintained at about 20,000 mPa·s or lower. Also, it is seen that as the viscosity of the viscous fluid is decreased, so is the damping effect decreased on the tilting part, and so is the possibility of overshooting increased. It is seen that in order for the possibility of overshooting of the tilting part 4 not to exceed about 10%, the viscosity of the viscous fluid must be maintained at about 5,000 mPa·s or higher.

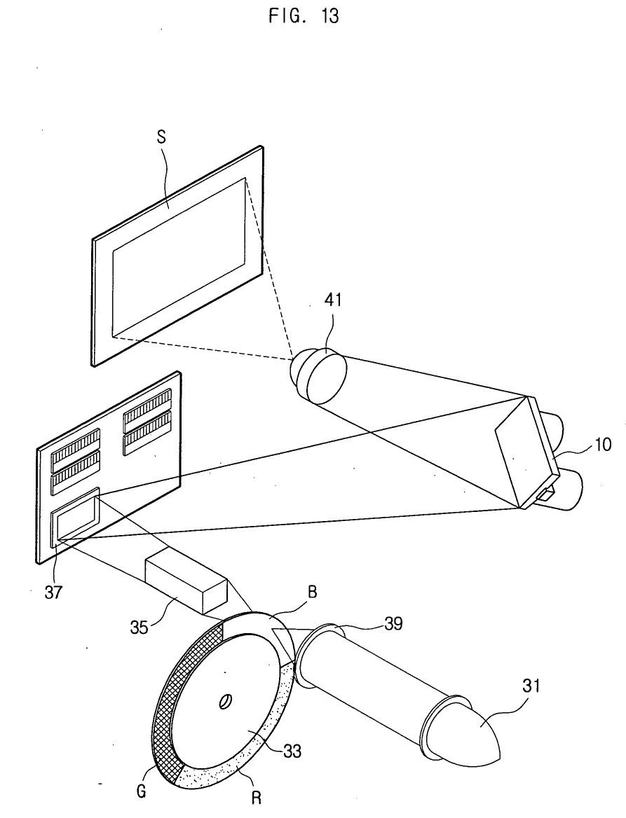

FIG. 13 is a schematic diagram of an image projection device according to an embodiment of the invention. An image projection device based on an embodiment of the invention comprises a light source 31, a color separation means 33, a quadrilateral beam generator part 35, an image forming means 37, a condenser lens 39, and a projection lens 41.

The light source 31 emits a white light comprising a plurality of monochromatic lights of different wavelengths, for example R (red), G (green), and B (blue) monochromatic lights, to the color separation means 33. For the light source 31, a laser, a mercury lamp, a metal halide lamp, a halogen lamp, or a xenon lamp, etc. may be used.

The color separation means 33 is a color wheel divided into the R (red), G (green), and B (blue) zones, and is rotated by a rotation means (not shown). The white light emitted from the light source 31 is sequentially divided into R•G•B monochromatic lights by the R•G•B zones of the color wheel, i.e. the color separation means. Each zone of the color wheel 33 is suitably coated according to the characteristics of each monochromatic light, and transmits the monochromatic light corresponding to each zone.

The quadrilateral beam generator part 35 converts the monochromatic light transmitted from the color separation means 33 to a quadrilateral beam having a predetermined length-width ratio. To do so, the quadrilateral beam generator part 35 uses a light tunnel or a glass rod (not shown). The light tunnel has a hexahedral shape, with a through hole in the middle. Also, mirrors are formed on the four sides inside the light tunnel. The respective R•G•B monochromatic lights that have passed through the color separation means 33 are converted to a quadrilateral beam within the light tunnel and emitted. Thus, a light with uniform intensity enters the image forming means 37. Here, the predetermined length-width ratio of the light tunnel is equal or similar to the length-width ratio of the image forming means 37. Also, the glass rod has a shape without a through hole and emits R•G•B monochromatic light respectively through total reflection.

The image forming means 37 forms an image using the quadrilateral beam transmitted from the quadrilateral beam generator part 35. Examples of the image forming means 37 may include a digital micro-mirror device (DMD) or an actuated mirror array (AMA). As the DMD and the AMA are publicly known, detailed explanations are omitted. The light transmitted from the image forming means is periodically tilted by a vibration type tilting device 10 based on an embodiment of the present invention by a particular angle and projected onto a screen S.

A brief explanation is provided below on the operation of an image projection device based on an embodiment of the invention comprised as above.

First, when the image projection device is activated, the light emitted from the light source 31 is focused onto a color wheel, i.e. the color separation means 33, by means of the condenser lens 39. The color wheel rotates at a certain speed and separates the light emitted from the light source 31 into R•G•B monochromatic lights. Thus, after passing through the color wheel, the white light is sequentially changed into red, green, and blue color beams, which are formed into quadrilateral beams by the quadrilateral beam generator part 35.

The quadrilateral beams from the quadrilateral beam generator part 35 are transmitted to the image forming means 37, so that an image is formed having a particular pixel structure. The light from the quadrilateral beam generator part 35 is transmitted to the tilting device 10, and with the tilting in constant time intervals, is magnified by the projection lens 41 and projected onto the screen S.

According to the present invention comprised as above mentioned, a smooth and natural display may be provided by periodically tilting light reflected from a digital micro-mirror device in constant intervals and reflecting it onto a screen.

Also, the invention may reduce overshooting and residual vibration of the tilting part, by controlling the damping coefficient of the tilting part, using a viscous fluid of a moderate amount and moderate viscosity, to provide superior tracking ability.

Although a few embodiments of the present invention have been shown and described, it will be appreciated by those skilled in the art that changes may be made in these embodiments without departing from the principles and spirit of the invention, the scope of which is defined in the appended claims and their equivalents.

1. A vibration type tilting device comprising: a tilting part, which vibrates periodically to tilt an incident light by a predetermined angle; and
a driving part, which provides driving power to the tilting part;
wherein the tilting part is damped by a viscous fluid during vibration.

2. The vibration type tilting device of claim 1, wherein the tilting part vibrates due to electromagnetic force generated by the driving part.

3. The vibration type tilting device of claim 1, wherein the tilting part comprises:
a mirror, reflecting light;
a mirror holder, having the mirror joined to a side thereof; and a coil, joined to the reverse side of the mirror holder.

4. The vibration type tilting device of claim 1, wherein the driving part comprises a magnet positioned with a particular amount of displacement from the tilting part and generating a magnetic field passing through the coil.

5. The vibration type tilting device of claim 4, wherein the driving part further comprises a yoke.

6. The vibration type tilting device of claim 1, wherein the driving part is positioned with a particular amount of displacement from the tilting part and comprises:
a magnet, generating a magnetic field passing through the coil; and
a core, in contact with the magnet.

7. The vibration type tilting device of claim 1, wherein the driving part comprises: a core, positioned with a particular amount of displacement from the mirror holder and having a portion thereof positioned inside the coil;
a yoke, positioned with a particular amount of displacement from the mirror holder and facing the perimeter of the coil; and
a magnet, positioned between the core and the yoke and magnetizing the core and the yoke; wherein the coil is damped by a viscous fluid during vibration.

8. The vibration type tilting device of claim 3, wherein the coil is formed on the reverse side of the mirror holder in bilateral symmetry.

9. The vibration type tilting device of claim 7, wherein the core comprises:
an insertion part, positioned inside the coil; and
a fixation part, having a diameter greater than that of the insertion part and formed on one end of the insertion part.

10. The vibration type tilting device of claim 9, wherein the magnet is inserted onto the insertion part and mounted on the fixation part.

11. The vibration type tilting device of claim 7, wherein the viscous fluid is inserted into a space formed between the coil and the core.

12. The vibration type tilting device of claim 7, wherein the viscous fluid is inserted into a space formed between the coil and the yoke.

13. The vibration type tilting device of claim 7, wherein the viscous fluid is inserted into a space formed between the core and the coil and between the coil and the yoke.

14. The vibration type tilting device of claim 7, wherein a magnetic fluid is inserted between the core and the magnet.

15. The vibration type tilting device of claim 7, wherein the viscous fluid has a viscosity of 5,000-20,000 mPa·s.

16. The vibration type tilting device of claim 7, wherein the viscous fluid selected from a group consisting of grease, glycerin, UV setting silicone, castor oil, SAE 30 oil, SAE 10W-30 oil, and SAE 10W oil.

17. The vibration type tilting device of claim 16, wherein the grease uses silicone oil as a base oil, and lithium, PTFE, or PAO as a thickener.

18. The vibration type tilting device of claim 16, wherein the grease has a consistency of 200-500.

19. An image projection device having a vibration type tilting device according to claim 1, comprising:
a light source;
a color separation means, which separates light emitted from the light source; and
an image forming means, which uses light transmitted from the color separation means to form an image;
wherein the vibration type tilting device periodically tilts in a particular angle the light transmitted from the image forming means.

20. The image projection device of claim 19, wherein the color separation means is a color wheel comprising red, green, and blue filters.

21. The image projection device of claim 19, wherein the image forming means is a digital micro-mirror device.
